(19) United States
(12) Patent Application Publication
(10) Pub. No.: US 2017/0017031 A1
(43) Pub. Date: Jan. 19, 2017

(54) Light pipe structure

(71) Applicant: COMPAL BROADBAND NETWORKS INC., Taipei City (TW)

(72) Inventors: Chiang-Chang Wu, Hsinchu County (TW); Cheng-Shan Lin, Hsinchu County (TW); Chung-Ming Pan, Hsinchu County (TW)

(21) Appl. No.: 15/043,607

(22) Filed: Feb. 14, 2016

Related U.S. Application Data
(60) Provisional application No. 62/193,099, filed on Jul. 16, 2015.

(30) Foreign Application Priority Data
Dec. 3, 2015 (TW) 104219405

(51) Int. Cl. F21V 8/00; F21V 17/10; F21K 99/00

(52) U.S. Cl. CPC G02B 6/0096; F21K 9/30; F21K 9/52; F21V 17/101

(57) ABSTRACT

A light pipe structure includes a light guide pillar and a light shade tube. The light guide pillar, which is composed of a transparent material, is used for transmitting light. The light guide pillar includes a cylinder hole disposed in a terminal of the light guide pillar. The light shade tube, which is composed of a non-transparent material, is a hollow cylinder capable of being inserted in the cylinder hole. The hollow cylinder of the light shade tube has a shrinking structure.

### CROSS REFERENCE TO RELATED APPLICATIONS

This application claims the benefit of U.S. Provisional Application No. 62/193,099, filed on Jul. 16, 2015, the contents of which are incorporated herein by reference.

### BACKGROUND OF THE INVENTION

1. Field of the Invention

The present invention relates to a light pipe structure, and more particularly, to a light pipe structure capable of preventing light scattering.

2. Description of the Prior Art

With developments of technology and advancements in the industry, electronic devices such as mobile phones, GPS navigator systems, tablets, laptops and wearable devices have become indispensable in our daily life. Most of the electronic devices are equipped with indicator lamps, for indicating operation statuses of the electronic devices to the user. Such operation statuses may be power status, battery status, or real-time message, etc. The light emitting diodes (LEDs), which are light emitters with high brightness and low power consumption, are capable of generating light indications with different colors. Therefore, the LEDs are usually utilized as the light sources of the indicator lamps.

However, the light sign of an indicator lamp should be strong and concentrated enough, while the light generated by an LED may be scattered and is required to undergo further processing to make it concentrated. In the prior art, an LED is painted with non-transparent materials except for the surface which needs to output light, allowing the light to be uniformly distributed on this surface. However, some light points may appear when the painting is non-uniform or when the paint is too thin in the painting operation. Alternatively, when the light emitted by the LED is too strong, light leakage may also occur. Thus, there is a need for improvement over the prior art.

### SUMMARY OF THE INVENTION

It is therefore an objective of the present invention to provide a light pipe structure, which is capable of preventing light scattering and light leakage and thereby achieves enough strength and concentration of light.

The present invention discloses a light pipe structure, which comprises a light guide pillar and a light shade tube. The light guide pillar, which is composed of a transparent material, is used for transmitting light. The light guide pillar comprises a cylinder hole disposed in a terminal of the light guide pillar. The light shade tube, which is composed of a non-transparent material, is a hollow cylinder capable of being inserted in the cylinder hole. The hollow cylinder of the light shade tube has a shrinking structure.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a structure of a light pipe according to an embodiment of the present invention.

FIG. 2 is a schematic diagram of a sectional view of a section of the light pipe shown in FIG. 1.

FIG. 3 is a side view diagram of a section of the light shade tube inserted in the light guide pillar.

### DETAILED DESCRIPTION

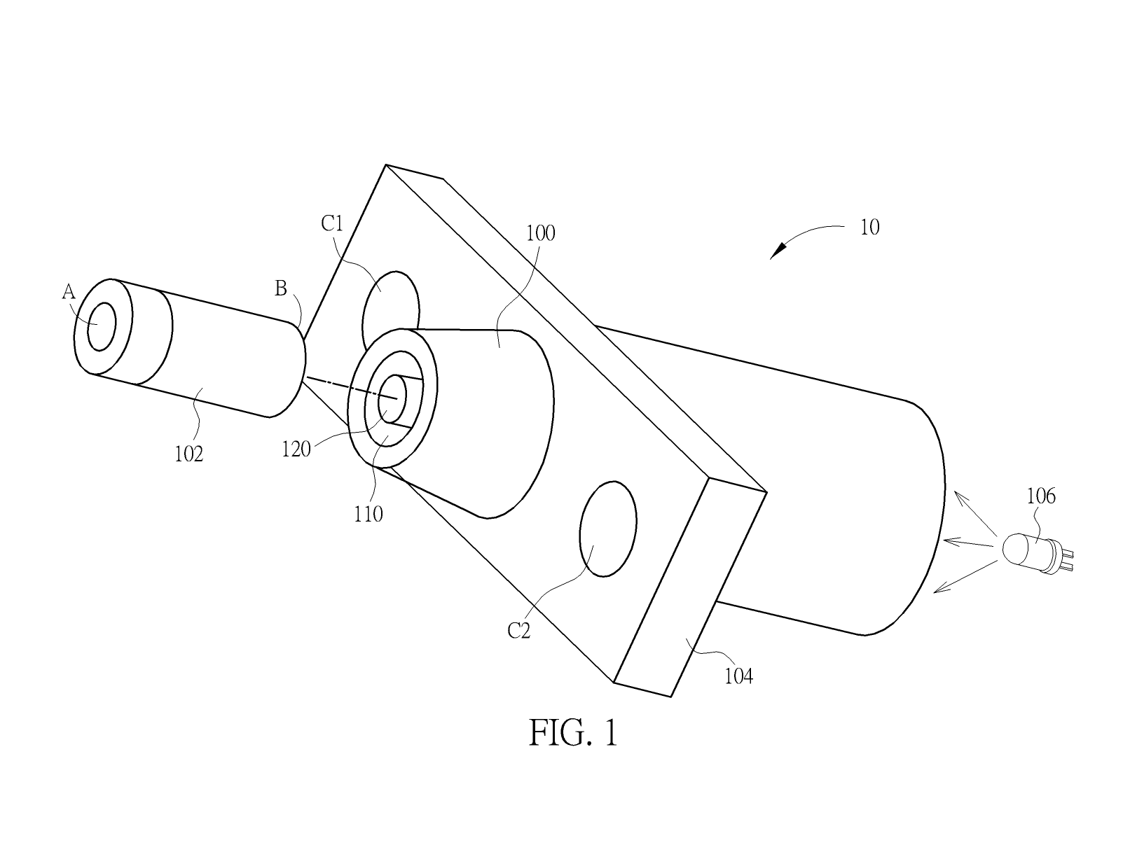

Please refer to FIG. 1, which is a schematic diagram of a structure of a light pipe 10 according to an embodiment of the present invention. As shown in FIG. 1, the light pipe 10 includes a light guide pillar 100, a light shade tube 102 and a fixing structure 104. A light emitting diode (LED) light source 106, which is disposed below the light guide pillar 100, is utilized for sending light. The light guide pillar 100 is composed of a transparent material, for transmitting light. The transparent material may be any material having high penetration to light. Preferably, the light guide pillar 100 may be a cylinder in order to achieve satisfactory light guide effects and light uniformity. However, in another embodiment, the light guide pillar may be a square pillar, triangular pillar or irregular polygonal pillar, etc. Further, the light guide pillar may also have a specific shape according to requirements of the electronic device, and is not limited herein. The light guide pillar 100 includes a cylinder hole 110 located in the upper terminal of the light pipe.

The light shade tube 102 is composed of a non-transparent material. The non-transparent material may be any material having low penetration to the light generated by the light source 106. The light shade tube 102 is a hollow cylinder, which is capable of being inserted in the cylinder hole 110 on the light guide pillar 100. The fixing structure 104 is disposed outside the light guide pillar 100, for fixing the light guide pillar 100 to an external device, e.g., an electronic device using the light source 106 and the light pipe 10 as an indicator lamp. The fixing structure 104 includes connecting nodes C1 and C2, which are used for connecting and fixing to the external device via heat welding. Please note that the fixing structure 104 aims at fixing the light pipe 10 to the external device, and the structure of the fixing structure 104 shown in FIG. 1 is only one of various implementations according to embodiments of the present invention. For example, the fixing structure 104 may include any number of connecting nodes, or may perform fixing by another method, which is not limited herein.

In FIG. 1, the light pipe 10 is of a light circle type; that is, the light emitted by the light source 106 may appear a light circle after passing through the light guide pillar 100. In such a condition, the cylinder hole 110 on the light guide pillar 100 is not entirely hollow. Instead, a smaller cylinder 120 is included and located in the center of the cylinder hole 110. The light appears to be a light circle emitted from areas outside the cylinder hole 110 and inside the cylinder 120. In order to prevent light scattering which results in a blurred light circle image, the light shade tube 102 may be inserted in the cylinder hole 110 to shade the light. The light shade tube 102 needs to be fully inserted in the cylinder hole 110 and closely combined with the cylinder hole 110, and the hollow part of the light shade tube 102 is also aligned to the cylinder 120 and the cylinder hole 110. Therefore, a complete light shading effect maybe achieved.

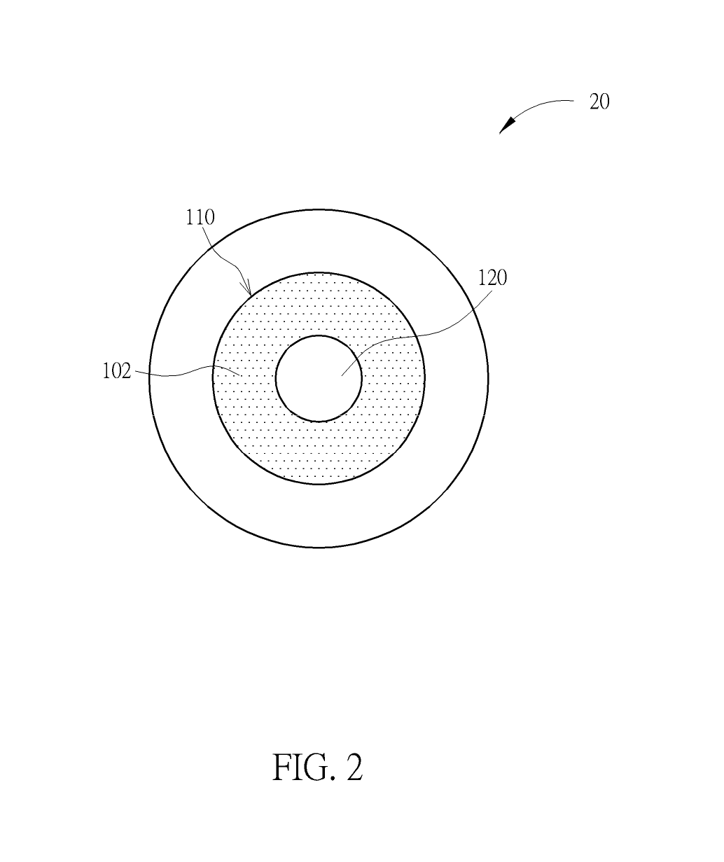

More specifically, please refer to FIG. 2, which is a schematic diagram of a sectional view of a section 20 of the light pipe 10. The section 20, which is located in the upper part of the light pipe 10, includes the cylinder hole 110, the cylinder 120 and the inserted part of the light shade tube 102. As shown in FIG. 2, the cylinder hole 110 appears to be a hollow circle, which includes a solid circle formed by the cylinder 120. When the hollow cylinder of the light shade tube 102 is inserted in the cylinder hole 110, the light may show through areas outside the hollow circle and inside the solid circle. As a result, the light outputted by the light pipe 10 may appear to be a light circle.

Please note that if the design of the light shade tube 102 entirely fits the cylinder hole 110 and the cylinder 120, the structures of these modules are not easily manufactured at all. In such a condition, any small error may cause that the light shade tube 102 fails to align with the cylinder 120 or cannot be inserted in the cylinder hole 110. In such a condition, the hollow cylinder of the light shade tube 102 is designed to have a shrinking structure, which solves the manufacturing problem.

Please keep referring to FIG. 1. In the light shade tube 102, the outer diameter and inner diameter in the terminal A are designed to be exactly aligned to the cylinder hole 110 and the cylinder 120 of the light guide pillar 100, respectively. The shape of the light shade tube 102 shrinks in the terminal B, i.e., the outer diameter of the cylinder shrinks. In this manner, the manufacture of the light shade tube 102 will become easier, and the light shade tube 102 is more easily to be inserted in the cylinder hole 110; this realizes a better light shading effect.

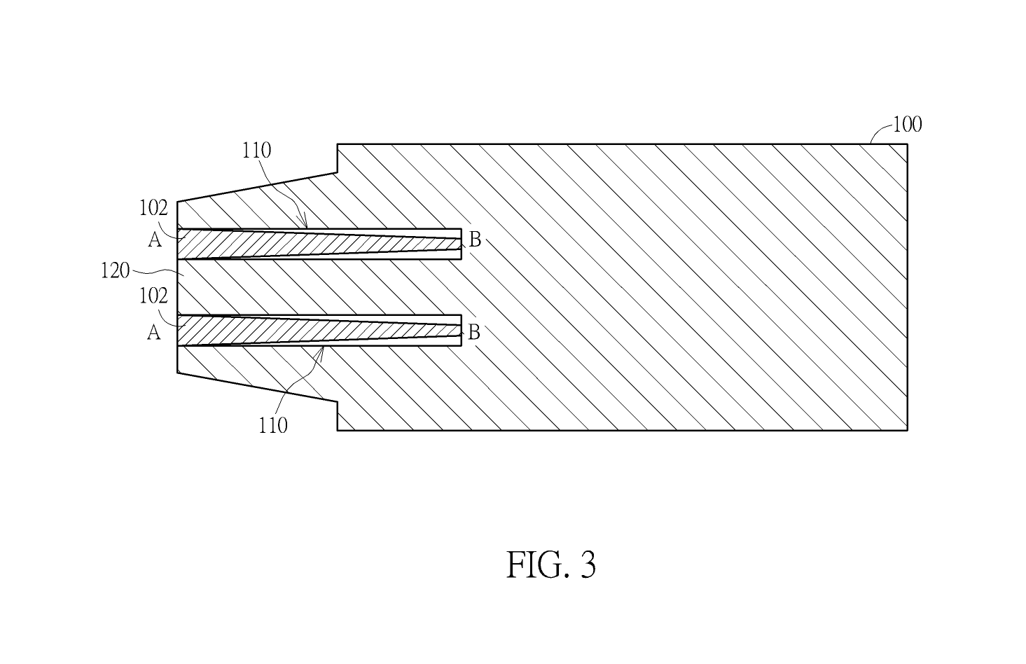

Please refer to FIG. 3, which is a side view diagram of a section of the light shade tube 102 inserted in the light guide pillar 100. As shown in FIG. 3, the light shade tube 102 is a hollow cylinder. The outer diameter and inner diameter in the terminal A of the light shade tube 102 are exactly aligned to the cylinder hole 110 and the cylinder 120, respectively, while the terminal B shrinks in contrast to the terminal A. In detail, the outer diameter of the terminal A is equal to the diameter of the cylinder hole 110, so that the terminal A of the light shade tube 102 may be exactly combined with the cylinder hole 110. The outer diameter of the terminal A is greater than the outer diameter of the terminal B, so that there is a little space between the terminal B of the light shade tube 102 and the cylinder hole 110. The inner diameter of the terminal A is smaller than the inner diameter of the terminal B, so that there is a little space between the terminal B of the light shade tube 102 and the cylinder 120. As a result, the light shade tube 102 may be easily inserted in the cylinder hole 110 to achieve a satisfactory light shading effect.

Please note that one of the spirits of the present invention is to provide a light pipe having a shrinking structure, allowing a little space existing between the light shade tube and the light guide pillar. In such a condition, the light shade tube can be inserted in the light guide pillar more easily, in order to achieve a satisfactory light shading effect and also enjoy the benefits of easy assembling and easy manufacturing. Those skilled in the art can make modifications and alternations accordingly. For example, in order to achieve satisfactory light guide effects and light uniformity, the light shade tube 102, the light guide pillar 100, the cylinder hole 110 and the cylinder 120 shown in FIG. 1 are all in cylinder shapes, but in another embodiment, the length and shape of these modules may be designed according to practical requirements, and should not be limited herein. In addition, the light source used with the light pipe is not limited to the LED light source, and may be another type of light source such as an incandescent light or high intensity discharge (HID) light.

In the prior art, the method of dealing with the light scattering problem is to cover the LED by painting it except for the surface which needs to output light, allowing the light to be uniformly distributed on this surface. However, some light points may appear when the painting is non-uniform or when the paint is too thin in the painting operation. Alternatively, when the light emitted by the LED is too strong, light leakage may also occur. In contrast, according to the present invention, a light pipe is utilized for guiding light. The light pipe includes a light guide pillar and a light shade tube, where the light shade tube may be inserted in a cylinder hole on the light guide pillar, so that the light pipe may output a clear light circle. In addition, the light shade tube has a shrinking structure, which allows the light pipe to have the benefits of easy assembling and easy manufacturing and also achieve a satisfactory light shading effect.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A light pipe structure, comprising:
a light guide pillar, composed of a transparent material, for transmitting light, the light guide pillar comprising a cylinder hole disposed in a terminal of the light guide pillar; and
a light shade tube, composed of a non-transparent material, wherein the light shade tube is a hollow cylinder capable of being inserted in the cylinder hole;
wherein the hollow cylinder of the light shade tube has a shrinking structure.

2. The light pipe structure of claim 1, wherein an outer diameter of a first terminal of the light shade tube is greater than an outer diameter of a second terminal of the light shade tube according to the shrinking structure.

3. The light pipe structure of claim 2, wherein an inner diameter of the first terminal of the light shade tube is smaller than an inner diameter of the second terminal of the light shade tube according to the shrinking structure.

4. The light pipe structure of claim 2, wherein the outer diameter of the first terminal of the light shade tube is substantially equal to a diameter of the cylinder hole of the light guide pillar.

5. The light pipe structure of claim 2, wherein the second terminal of the light shade tube is inserted in the cylinder hole of the light guide pillar and the first terminal of the light shade tube is aligned to the cylinder hole.

6. The light pipe structure of claim 1, wherein a section of the cylinder hole comprises a hollow circle which further comprises a solid circle, and the light shows through areas outside the hollow circle and inside the solid circle when the light shade tube is inserted in the cylinder hole.

7. The light pipe structure of claim 1, wherein a light source is disposed in another terminal of the light guide pillar, for sending the light, wherein the other terminal is opposite to the cylinder hole.

8. The light pipe structure of claim 7, wherein the light source is a light emitting diode (LED) light source.

9. The light pipe structure of claim 1, further comprising:
a fixing structure, disposed outside the light guide pillar, for fixing the light guide pillar to an external device.

10. The light pipe structure of claim 9, wherein the fixing structure comprises at least one connecting node, for connecting and fixing to the external device via heat welding.
